(19) United States
(12) Patent Application Publication
(10) Pub. No.: US 2013/0240274 A1
(43) Pub. Date: Sep. 19, 2013

(54) EXPANDABLE VEHICLE SYSTEMS

(71) Applicant: GM Global Technology Operations LLC, (US)

(72) Inventors: Robert L. Vitale, Macomb Township, MI (US); Christopher E. Borroni-Bird, Oakland Township, MI (US); Roland J. Menassa, Macomb, MI (US)

(73) Assignee: GM GLOBAL TECHNOLOGY OPERATIONS LLC, Detroit, MI (US)

(21) Appl. No.: 13/747,512

(22) Filed: Jan. 23, 2013

Related U.S. Application Data
(63) Continuation-in-part of application No. 13/421,923, filed on Mar. 16, 2012.
Application No. 13/421,923 is a continuation-in-part of application No. 13/467,521, filed on May 9, 2012.

(51) Int. Cl. B62D 21/14; B60K 1/00

(52) U.S. Cl. CPC B62D 21/14; B60K 1/00
USPC 180/65.1

(57) ABSTRACT

An expandable vehicle system includes a base unit having a frame, a first wheel rotatably mounted with respect to the frame, and a battery-electric propulsion system mounted with respect to the frame. The expandable vehicle system also includes a first extension module having a first vehicle body portion and an auxiliary power unit mounted with respect to the first vehicle body portion. The base unit has a first attachment interface mounted with respect to the frame and the first extension module has a second attachment interface mounted with respect to the first vehicle body portion. The first and second attachment interfaces are configured to selectively and releasably engage one another such that the first extension module and the base unit form a single drivable unit when the first and second attachment interfaces are engaged with one another.

### CROSS REFERENCE TO RELATED APPLICATIONS

This application is a continuation in part of U.S. patent application Ser. No. 13/421,923, filed Mar. 16, 2012 and U.S. patent application Ser. No. 13/467,521, filed May 9, 2012, both of which are hereby incorporated by reference in their entireties.

### TECHNICAL FIELD

The present teachings generally include a drivable vehicle that can be selectively expanded.

### BACKGROUND

An individual may have different mobility needs on different occasions. For example, the individual may work in an urban area and need to commute to work on a daily basis. For these commuting needs, a fuel efficient vehicle that seats at least the driver and is of a small size that is easy to maneuver and park in a congested area is ideal. On other occasions, the driver may need to transport one or more additional passengers or cargo, may need or desire a higher performance vehicle, or may need to travel a further distance than the typical commute to and from work. Heretofore, the driver would need to use a different vehicle for these occasions.

### SUMMARY

An expandable vehicle system includes a base unit having a frame, a first wheel rotatably mounted with respect to the frame, and a battery-electric propulsion system mounted with respect to the frame. The expandable vehicle system also includes a first extension module having a first vehicle body portion and an auxiliary power unit mounted with respect to the first vehicle body portion. The base unit has a first attachment interface mounted with respect to the frame and the first extension module has a second attachment interface mounted with respect to the first vehicle body portion. The first and second attachment interfaces are configured to selectively and releasably engage one another such that the first extension module and the base unit form a single drivable unit when the first and second attachment interfaces are engaged with one another.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic side view illustration of a first embodiment of an expandable vehicle system including a base unit with a first extension module connected thereto;

FIG. 2 is a schematic side view illustration of the base unit of FIG. 1 with a second extension module connected thereto;

FIG. 3 is a schematic side view illustration of a second embodiment of an expandable vehicle system including a base unit having a frame in a retracted position;

FIG. 4 is a schematic side view illustration of the base unit of FIG. 3 with the frame in an extended position and an extension module connected thereto;

FIG. 5 is a schematic side view illustration of a base unit of a third embodiment of an expandable vehicle system;

FIG. 6 is a schematic side view illustration of an extension module of the third embodiment of an expandable vehicle system;

FIG. 7 is a schematic side view illustration of the extension module of FIG. 6 connected to the base unit of FIG. 5;

FIG. 8 is a schematic side view illustration of a fourth embodiment of an expandable vehicle system including a base unit with a first extension module connected thereto.;

FIG. 9 is a schematic side view illustration of the base unit of FIG. 8 with a second extension module connected thereto;

FIG. 10 is a schematic side view illustration of a fifth embodiment of an expandable vehicle system including a base unit with an extension module connected thereto;

FIG. 11 is a schematic illustration of the base unit and extension module of FIG. 10 including respective steering and braking systems;

FIG. 12 is a schematic side view illustration of a sixth embodiment of an expandable vehicle system including a base unit with an extension module connected thereto; and

FIG. 13 is a schematic illustration of the base unit and extension module of FIG. 12 including respective steering and braking systems.

### DETAILED DESCRIPTION

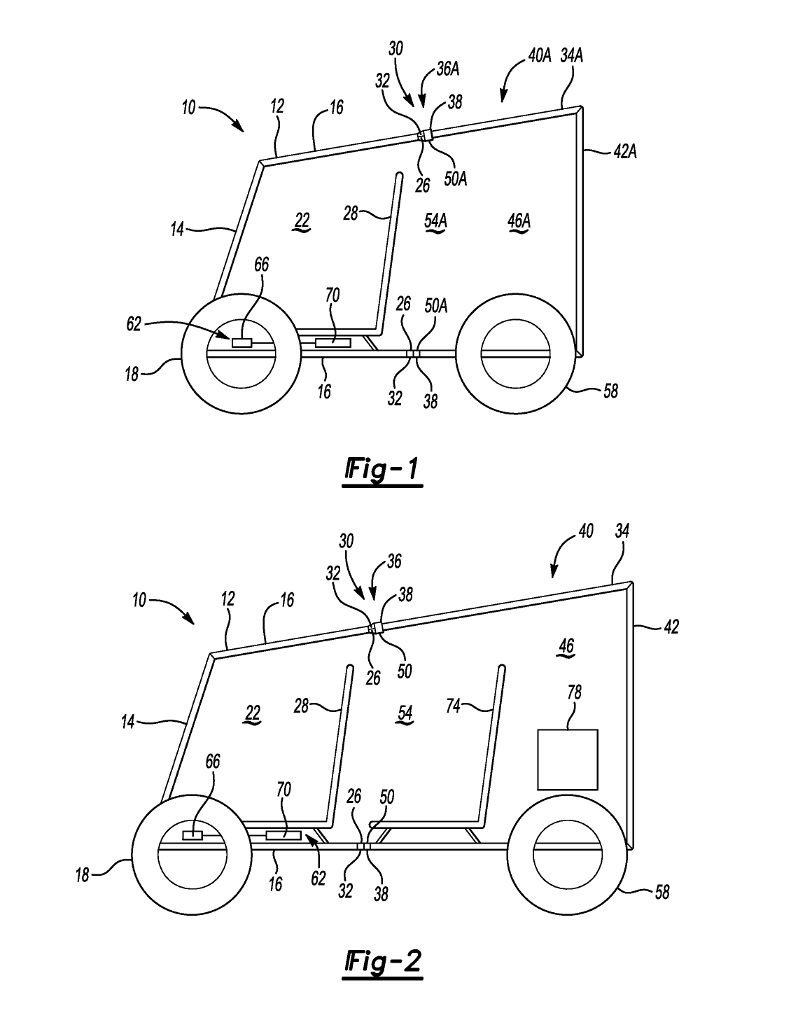

Referring to FIGS. 1 and 2, an expandable vehicle system 10 includes a base unit 12, which includes a vehicle body portion 14. The body portion 14 includes structure that functions as a frame 16. As used herein, a “frame” may include structure that provides structural integrity, and may be part of a vehicle body. The base unit 12 includes two front wheels 18 (only one of which is shown in FIG. 1) rotatably mounted with respect to the frame 16. The body portion 14 of the base unit 12 partially defines an interior compartment 22 having an opening 26 at the rearward end of the body portion 14. The base unit 12 includes a driver's seat 28 disposed within the interior compartment 22 and mounted to the body portion 14. The base unit 12 also includes other systems (not shown) to enable drivability, such as a steering system and a braking system.

The base unit 12 also includes a first attachment interface 30 mounted with respect to the frame 16 adjacent the opening 26 at the rearward end of the body portion 14; the first attachment interface 30 in the embodiment depicted includes at least one mechanical fastening element 32.

The expandable vehicle system 10 also includes two rear modules, or extension modules, that are selectively and releasably engageable at the first attachment interface 30. More specifically, the expandable vehicle system 10 includes a first extension module, shown at 34 in FIG. 2, and a second extension module, shown at 34A in FIG. 1. Referring specifically to FIG. 2, the first extension module 34 includes a vehicle body portion 42. The first extension module 34 also includes a second attachment interface 36 that is mounted to the body portion 42; in the embodiment depicted, the second attachment interface 36 includes mechanical fastening elements 38 that are selectively and releasably engageable with the fastening elements 32 of the first attachment interface 30 to connect the first extension module 34 to the base unit 12 such that the first extension module 34 and the base unit 12 form a single drivable unit 40, as shown in FIG. 2. In the embodiment depicted, fastening elements 32, 38 rigidly interconnect the base unit 12 with the first extension module 34.

The mechanical fastening elements 32, 38 may have many different configurations within the scope of the claimed invention. For example, mechanical fastening elements 32 may be latches and fastening elements 38 may be strikers that releasably engage the latches, fastening elements 32 may be threaded fasteners and fastening elements 38 may be tabs with holes through which the threaded fasteners extend (a nut would then engage the threaded fasteners to secure the tabs), etc.

The first extension module 34 includes a body portion 42 that defines an interior compartment 46 having an opening 50 at the forward end of the body portion 42 adjacent fastening elements 38. The opening 26 of interior compartment 22 is adjacent the opening 50 of interior compartment 46 when extension module 34 is mounted to the body portion 14 via the fastening elements 32, 38 (i.e., the first and second attachment interfaces 30, 36), and the interior compartments 22, 46 cooperate to form one contiguous compartment 54. The extension module 34 has two wheels 58 (only one of which is shown in FIG. 2) rotatably connected thereto. The wheels 58 of the extension module 34 form the rear wheels of the drivable unit 40.

The base unit 12 in the embodiment depicted includes a battery-electric powertrain or propulsion system 62 mounted with respect to the frame 16. The battery-electric propulsion system includes an electric motor 66 operatively connected to an energy storage device, such as a battery 70. As used herein, a “battery electric propulsion system” or a “battery-electric powertrain” includes a battery or other electrical energy storage device and an electric motor operatively connected to the battery to receive electrical energy therefrom; the motor is operatively connected to at least one of the vehicle wheels 18, 58 to transmit torque thereto and thereby propel the vehicle system 10.

The first extension module 34 also includes an auxiliary power unit 78 mounted with respect to the first vehicle body portion 42. As used herein, an “auxiliary power unit” is any device that produces power to propel the vehicle system 10; examples of auxiliary power units 78 include torque-producing devices, such as internal combustion engines, that transmit torque to at least one of the wheels 18, 54. Other auxiliary power units 78 within the scope of the claimed invention may generate electrical energy to power the electric motor 66 or recharge the battery 70, such as an internal combustion engine in combination with a generator, or a fuel cell. Accordingly, the interfaces 30, 36 may include an electrical interface (not shown) to transmit control signals to the auxiliary power unit 78 or to transmit electrical energy from the auxiliary power unit 78 to the battery 70 and/or the motor 66.

Referring specifically to FIG. 1, the second extension module 34A includes a body portion 42A. The second extension module 34A also includes a third attachment interface 36A that is mounted with respect to the body portion 42A; in the embodiment depicted, the third attachment interface 36A includes mechanical fastening elements 38 that are selectively and releasably engageable with the fastening elements 32 of the first attachment interface 30 to rigidly connect the second extension module 34A to the base unit 12 such that the base unit 12 and the second extension module 34A form a single, drivable unit 40A.

The second extension module 34A includes a body portion 42A that defines an interior compartment 46A having an opening 50A at the forward end of the body portion 42A adjacent fastening elements 38. The opening 26 of interior compartment 22 is adjacent the opening 50A of interior compartment 46A when the second extension module 34A is mounted to the base unit 12 via the fastening elements 30, 38, and the interior compartments 22, 46A cooperate to form one contiguous compartment 54A. The second extension module 34A has two wheels 58 rotatably connected thereto. The wheels 58 of the second extension module 34A form the rear wheels of the drivable unit 40A when the second extension module 34A is attached to the body portion 14.

Referring to FIGS. 1 and 2, the interior compartment 46A of the second extension module 34A is shorter and smaller than the interior compartment 46 of the first extension module 34, and thus the interior compartment 54A formed when the second extension module 34A is attached to the base unit 12 is shorter and smaller than the interior compartment 54 formed when the first extension module 34 is attached to the base unit 12. The second extension module 34A is characterized by the absence of an auxiliary power unit 78, and thus drivable unit 40A is a compact, electric vehicle. Accordingly, the second extension module 34A may be used, for example, for one or two people commuting short distances.

When a user of the vehicle system 10 desires additional cargo space, passenger capacity, and/or driving range before recharging the battery 70, the user may remove the second extension module 34A from the base unit 12 (by disengaging the fastening elements 38 of the third attachment interface 36A from the fastening elements 32 of the first attachment interface 30) and then engage the fastening elements 38 of the second attachment interface 36 with the fastening elements 32 of the first attachment interface 30 to attach the first extension module 34 to the base unit 12. The first extension module 34 provides increased cargo space and/or passenger capacity compared to the second extension module 34A, and the auxiliary power unit 78 provides additional power and or/driving range to the vehicle system 10. When a user of the vehicle system 10 desires a compact, electric-only vehicle, then the user may disconnect the first extension module 34 from the base unit 12 and then connect the second extension module 34A to the base unit 12. In the embodiment depicted, the first extension module 34 has at least one passenger seat 74 mounted to the body portion 42 and disposed within the interior compartment 46.

Thus, the expandable vehicle system 10 includes a base unit 12 having a frame 16, a first wheel 18 rotatably mounted with respect to the frame 16, and a battery-electric propulsion system 62 mounted with respect to the frame 16. A first extension module 34 has a first vehicle body portion 42 and an auxiliary power unit 78 mounted with respect to the first vehicle body portion 42. The base unit 12 has a first attachment interface 30 mounted with respect to the frame 16 and the first extension module 34 has a second attachment interface 36 mounted with respect to the first vehicle body portion 42. The first and second attachment interfaces 30, 36 are configured to selectively and releasably engage one another such that the first extension module 34 and the base unit 12 form a single drivable unit 40 when the first and second attachment interfaces are engaged with one another.

The base unit 12 includes a second vehicle body portion 14 mounted with respect to the frame 16. The first vehicle body portion 42 defines a first interior compartment 46 having a first opening 50. The second vehicle body portion 14 defines a second interior compartment 22 having a second opening 26. The first attachment interface 30 is positioned with respect to the second body portion 14, and the second attachment interface 36 is positioned with respect to the first body portion 42 such that the first and second interior compartments 46, 22 are contiguous when the first and second attachment interfaces 30, 36 are engaged with each other.

The vehicle system 10 also includes a second extension module 34A having a third vehicle body portion 42A and a third attachment interface 36A mounted with respect to the third vehicle body portion 42A. The first and third attachment interfaces 30, 36A are configured to selectively and releasably engage one another such that the second extension module 34A and the base unit 12 form a single drivable unit 40A when the first and third attachment interfaces 30, 36A are engaged with one another.

The third vehicle body portion 42A defines a third interior compartment 46A having a third opening 50A. The first attachment interface 30 is positioned with respect to the second body portion 14, and the third attachment interface 36A is positioned with respect to the third body portion 42A such that the third and second interior compartments 46A, 22 are contiguous when the first and third attachment interfaces 30, 36A are engaged with each other. The third interior compartment 46A is smaller than the first interior compartment 46.

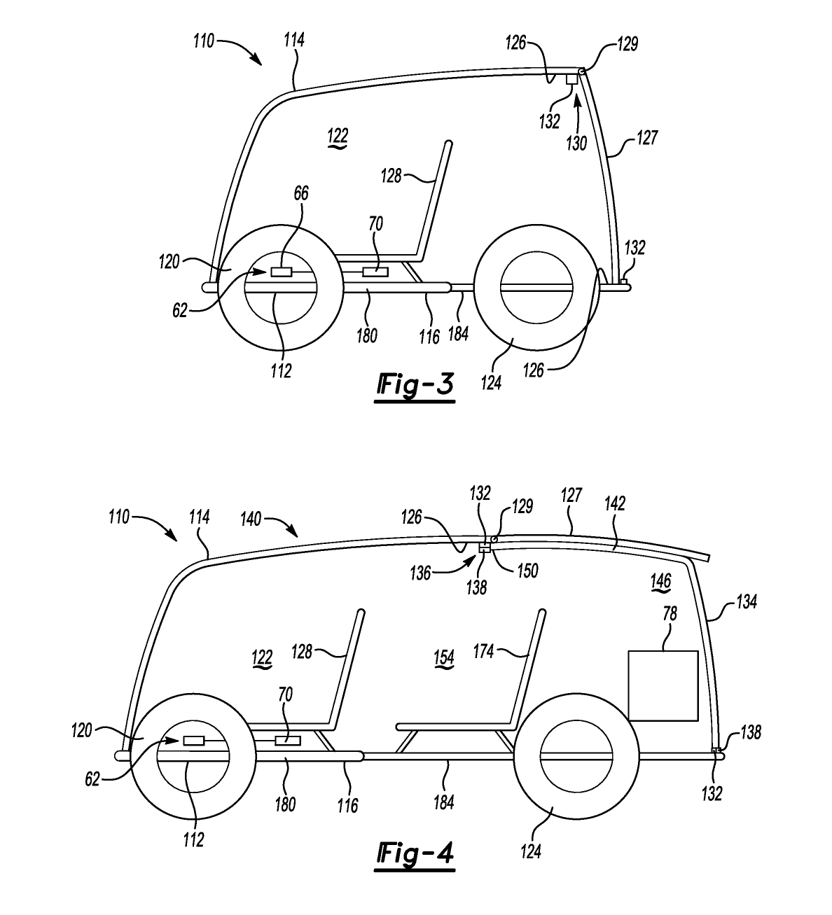

Referring to FIGS. 3 and 4, wherein like reference numbers refer to like components from FIGS. 1 and 2, an expandable vehicle system 110 includes a base unit 112 having a frame 116, a first wheel (front wheel 120) and a second wheel (rear wheel 124) rotatably mounted with respect to the frame 116, and a battery-electric propulsion system 62 mounted with respect to the frame 116. Only one front wheel 120 and one rear wheel 124 is shown in FIGS. 3 and 4; the base unit may include at least one other front wheel and rear wheel.

The battery-electric propulsion system 62 includes a motor 66 operatively connected to at least one of the wheels 120, 124 to transmit torque thereto. A battery 70 is operatively connected to the motor 66 to transmit electrical energy thereto. The base unit 112 in the embodiment depicted includes a body portion 114 that defines an interior compartment 122 having an opening 126 at the rearward end of the body portion 114. The base unit 112 also includes a vehicle body closure 127 that is configured to selectively obstruct the opening 126. In the embodiment depicted, the closure 127 is a rear liftgate that is selectively movable between a closed position, as shown in FIG. 3, in which the liftgate is generally vertical and obstructs the opening 126, and an open position, as shown in FIG. 4, in which the liftgate is generally horizontal and does not obstruct the opening 126. In the embodiment depicted, the closure 127 is pivotable about a hinge 129 that interconnects the closure 127 and the body portion 114. The base unit 112 includes a driver's seat 128 disposed within the interior compartment 122 and mounted to the body portion 114. The base unit 112 also includes other systems (not shown) to enable drivability, such as a steering system and a braking system.

The base unit 112 also includes a first attachment interface 130 mounted with respect to the frame 116 adjacent the opening 126 at the rearward end of the body portion 114; the first attachment interface 130 in the embodiment depicted includes at least one mechanical fastening element 132. In the embodiment depicted, one of the fastening elements 132 is mounted to the body 114 and one of the fastening elements 132 is mounted to the frame 116.

The frame 116 includes a first frame portion 180 and a second frame portion 184. The second frame portion 184 is selectively movable with respect to the first frame portion 180 to change the length of the frame 116. In the embodiment depicted, the first frame portion 180 is a first rail, and the second frame portion is a second rail. The first rail 180 defines a channel (not shown) in which the second rail 184 is selectively slidable with respect to the first rail 180. The second rail 184 is shown in a retracted position in FIG. 3 and an extended position in FIG. 4. In the retracted position, the second rail 184 does not extend outward from the first rail 180 as far as it does in the extended position. As seen in FIGS. 3 and 4, the length of the frame 116 is thus dependent upon the position of the second rail 184 with respect to the first rail 180. The frame 116 in the embodiment depicted includes a duplicate set of rails (not shown) that are parallel to the first and second rails 180, 184 and that are connected to the first and second rails by cross members (not shown).

The front wheel 120 is mounted with respect to the first rail 180, and the rear wheel 124 is mounted with respect to the second rail 184. Accordingly, movement of the second rail 184 with respect to the first rail 180 alters the wheelbase of the base unit 112, as seen in FIGS. 3 and 4.

When the second rail 184 is in the retracted position, the base unit 112 is a compact, battery-electric vehicle. When the second rail 184 is in the extended position, an extension module 134 may be attached to the base unit 112 to provide additional cargo space, passenger capacity, power, and/or driving range, as shown in FIG. 4. More specifically, the extension module 134 includes a vehicle body portion 142. The extension module 134 also includes a second attachment interface 136 that is mounted to the body portion 142; in the embodiment depicted, the second attachment interface 136 includes mechanical fastening elements 138 that are selectively and releasably engageable with the fastening elements 132 of the first attachment interface 130 to connect the extension module 134 to the base unit 112 such that the extension module 134 and the base unit 112 form a single drivable unit 140, as shown in FIG. 4. In the embodiment depicted, fastening elements 132, 138 rigidly interconnect the base unit 112 with the extension module 134.

The mechanical fastening elements 132, 138 may have many different configurations within the scope of the claimed invention. For example, mechanical fastening elements 132 may be latches and fastening elements 138 may be strikers that releasably engage the latches, fastening elements 132 may be threaded fasteners and fastening elements 138 may be tabs with holes through which the threaded fasteners extend (a nut would then engage the threaded fasteners to secure the tabs), etc.

The body portion 142 of the extension module 134 defines an interior compartment 146 having an opening 150 at the forward end of the body portion 142. The opening 126 of interior compartment 122 is adjacent the opening 150 of interior compartment 146, and when extension module 134 is mounted to the body portion 114 of the base unit 112 via the fastening elements 132, 138 (i.e., the first and second attachment interfaces 130, 136), the interior compartments 122, 146 cooperate to form one contiguous compartment 154. Thus, the first attachment interface 130 is positioned with respect to body portion 114, and the second attachment interface 136 is positioned with respect to body portion 142 such that the first and second interior compartments 146, 122 are contiguous when the first and second attachment interfaces 130, 136 are engaged with each other. It should be noted that the closure 127 is in the open position, and therefore not obstructing opening 126, when the extension module 134 is connected to the base unit 112. The closure 127 in the open position may be supported by, or connected to, the roof of body portion 142, as shown in FIG. 4.

The extension module 134 also includes an auxiliary power unit 78 mounted with respect to the first vehicle body portion 142. The auxiliary power unit 78 may be an internal combustion engine that transmits torque to at least one of the wheels 120, 124. The auxiliary power unit 78 may also generate electrical energy to power the electric motor 66 or recharge the battery 70, such as an internal combustion engine in combination with a generator, or a fuel cell. Accordingly, the interfaces 130, 136 may include an electrical interface to transmit control signals to the auxiliary power unit 78 from the base unit 112, or to transmit electrical energy from the auxiliary power unit 78 to the battery 70 and/or the motor 66 in the base unit 112.

When a user of the vehicle system 110 desires additional cargo space, passenger capacity, and/or driving range before recharging the battery 70, the user may extend the frame 116 of the base unit 112 (by sliding the second rail 184 rearward with respect to the first rail 180), open the closure 127, and then engage the fastening elements 138 of the second attachment interface 136 with the fastening elements 132 of the first attachment interface 130 to attach the extension module 134 to the base unit 112. The extension module 134 provides increased cargo space and/or passenger capacity to the base unit 112, and the auxiliary power unit 78 provides additional power and or/driving range to the vehicle system 110. When a user of the vehicle system 110 desires a compact, electric-only vehicle, then the user may disconnect the extension module 134 from the base unit 112, and then move the second rail 184 forward with respect to the first rail 180 (to the retracted position). The base unit 112 is then drivable as a compact, battery-electric vehicle. In the embodiment depicted, the extension module 134 has at least one passenger seat 174 mounted to the body portion 142 and disposed within the interior compartment 146.

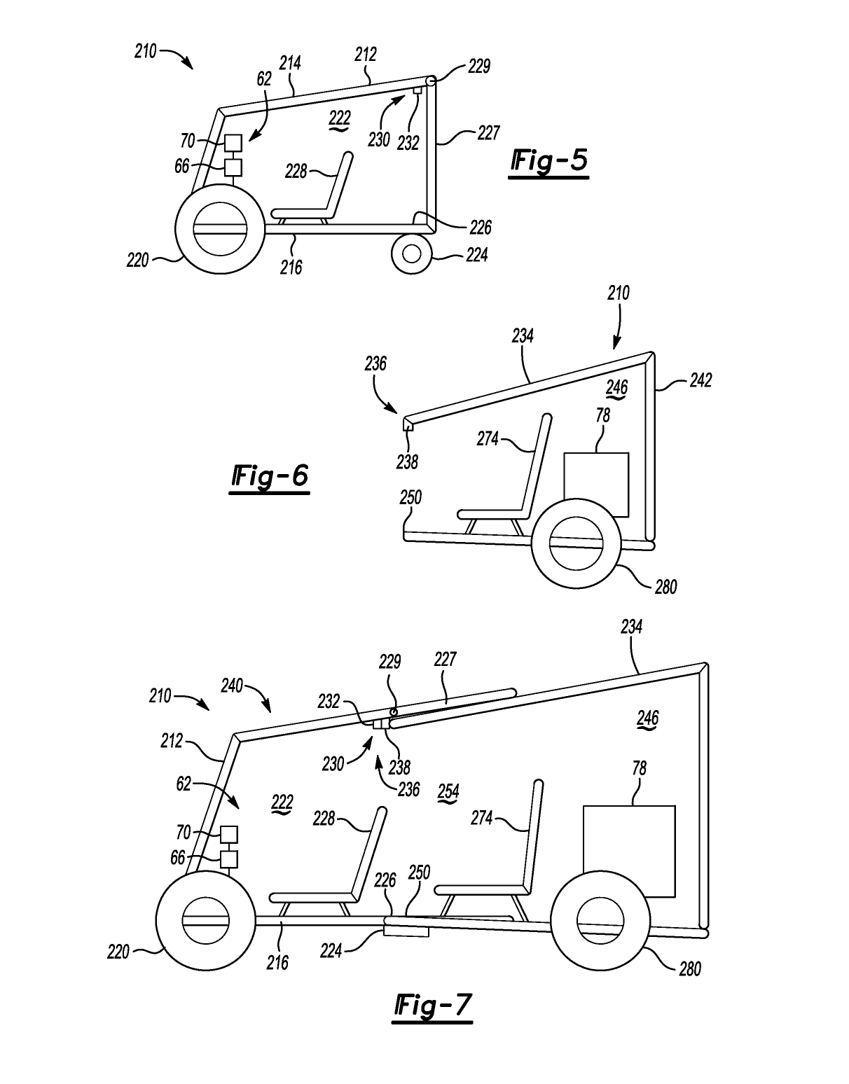

Referring to FIG. 5, wherein like reference numbers refer to like components from FIGS. 1-4, an expandable vehicle system 210 includes a base unit 212 having a frame 216, a first wheel (front wheel 220) and a second wheel (rear wheel 224) rotatably mounted with respect to the frame 216, and a battery-electric propulsion system 62 mounted with respect to the frame 216. Only one front wheel 220 and one rear wheel 224 is shown in FIG. 5; the base unit 212 may include at least one other front wheel and rear wheel.

The battery-electric propulsion system 62 includes a motor 66 operatively connected to at least one of the wheels 220, 224 to transmit torque thereto. A battery 70 is operatively connected to the motor 66 to transmit electrical energy thereto. The base unit 212 includes a body portion 214 that defines an interior compartment 222 having an opening 226 at the rearward end of the body portion 214. The base unit 212 also includes a vehicle body closure 227 that is configured to selectively obstruct the opening 226. In the embodiment depicted, the closure 227 is a rear liftgate that is selectively movable between a closed position, as shown in FIG. 5, in which the liftgate is generally vertical and obstructs the opening 226, and an open position, as shown in FIG. 7, in which the liftgate is generally horizontal and does not obstruct the opening 226. In the embodiment depicted, the closure 227 is pivotable about a hinge 229 that interconnects the closure 227 and the body portion 214. The base unit 212 includes a driver's seat 228 disposed within the interior compartment 222 and mounted to the body portion 214. The base unit 212 also includes other systems (not shown) to enable drivability, such as a steering system and a braking system.

The base unit 212 also includes a first attachment interface 230 mounted with respect to the frame 216 adjacent the opening 226 at the rearward end of the body portion 214; the first attachment interface 230 in the embodiment depicted includes at least one mechanical fastening element 232.

The base unit 212 is a compact, battery-electric vehicle. An extension module (shown at 234 in FIGS. 6 and 7) may be attached to the base unit 212 to provide additional cargo space, passenger capacity, power, and/or driving range, as shown in FIG. 7. Referring specifically to FIG. 6, wherein like reference numbers refer to like components from FIGS. 1-5, the extension module 234 includes a vehicle body portion 242. The extension module 234 also includes a second attachment interface 236 that is mounted to the body portion 242; in the embodiment depicted, the second attachment interface 236 includes mechanical fastening elements 238 that are selectively and releasably engageable with the fastening elements 232 of the first attachment interface 230 to connect the extension module 234 to the base unit 212 such that the extension module 234 and the base unit 212 form a single drivable unit 240, as shown in FIG. 7. In the embodiment depicted, fastening elements 232, 238 rigidly interconnect the base unit 212 with the extension module 234.

The mechanical fastening elements 232, 238 may have many different configurations within the scope of the claimed invention. For example, mechanical fastening elements 232 may be latches and fastening elements 238 may be strikers that releasably engage the latches, fastening elements 232 may be threaded fasteners and fastening elements 238 may be tabs with holes through which the threaded fasteners extend (a nut would then engage the threaded fasteners to secure the tabs), etc.

The body portion 242 of the extension module 234 defines an interior compartment 246 having an opening 250 at the forward end of the body portion 242. The opening 226 of interior compartment 222 is adjacent the opening 250 of interior compartment 246 when extension module 234 is mounted to the body portion 214 of the base unit 212 via the fastening elements 232, 238 (i.e., the first and second attachment interfaces 230, 136), and the interior compartments 222, 246 cooperate to form one contiguous compartment 254. Thus, the first attachment interface 230 is positioned with respect to body portion 214, and the second attachment interface 236 is positioned with respect to body portion 242 such that the first and second interior compartments 246, 222 are contiguous when the first and second attachment interfaces 230, 236 are engaged with each other. It should be noted that the closure 227 is in the open position, and therefore not obstructing opening 226, when the extension module 234 is connected to the base unit 212. The closure 227 in the open position may be supported by, or connected to, the roof of body portion 242, as shown in FIG. 7.

The extension module 234 includes at least one wheel 280 mounted with respect to the body portion 242. The rear wheel 224 of the base unit is selectively retractable; in FIG. 5 the wheel 224 is shown in an extended position in which the wheel 224 rotatably supports the base unit 212 on the ground, and in which the wheel 224 enables the base unit 212 to operate as a fully functional vehicle without the extension module 234. In FIG. 7, the wheel 224 is shown in a retracted position relative to the frame 216, in which the wheel 224 does not contact the ground. Wheels 280 of the extension module 234 then form the rear wheels of the drivable unit 240.

The extension module 234 also includes an auxiliary power unit 78 mounted with respect to the vehicle body portion 242. The auxiliary power unit 78 may be an internal combustion engine that transmits torque to at least one of the wheels 220, 280. The auxiliary power unit 78 may also generate electrical energy to power the electric motor 66 or recharge the battery 70, such as an internal combustion engine in combination with a generator, or a fuel cell. Accordingly, the interfaces 230, 236 may include an electrical interface (not shown) to transmit control signals to the auxiliary power unit 78 from the base unit 212, or to transmit electrical energy from the auxiliary power unit 78 to the battery 70 and/or the motor 66 in the base unit 212.

When a user of the vehicle system 210 desires additional cargo space, passenger capacity, and/or driving range before recharging the battery 70, the user may open the closure 227, and then engage the fastening elements 238 of the second attachment interface 236 with the fastening elements 232 of the first attachment interface 230 to attach the extension module 234 to the base unit 212. After the extension module 234 is connected to the base unit 212, the wheel 224 may then be retracted. The extension module 234 provides increased cargo space and/or passenger capacity to the base unit 212, and the auxiliary power unit 78 provides additional power and or/driving range to the vehicle system 210. When a user of the vehicle system 210 desires a compact, electric-only vehicle, then the user may extend wheel 224 to the position shown in FIG. 5, disconnect the extension module 234 from the base unit 212, and then move the closure 227 to the closed position. The base unit 212 is then drivable as a compact, battery-electric vehicle. In the embodiment depicted, the extension module 234 has at least one passenger seat 274 mounted to the body portion 242 and disposed within the interior compartment 246.

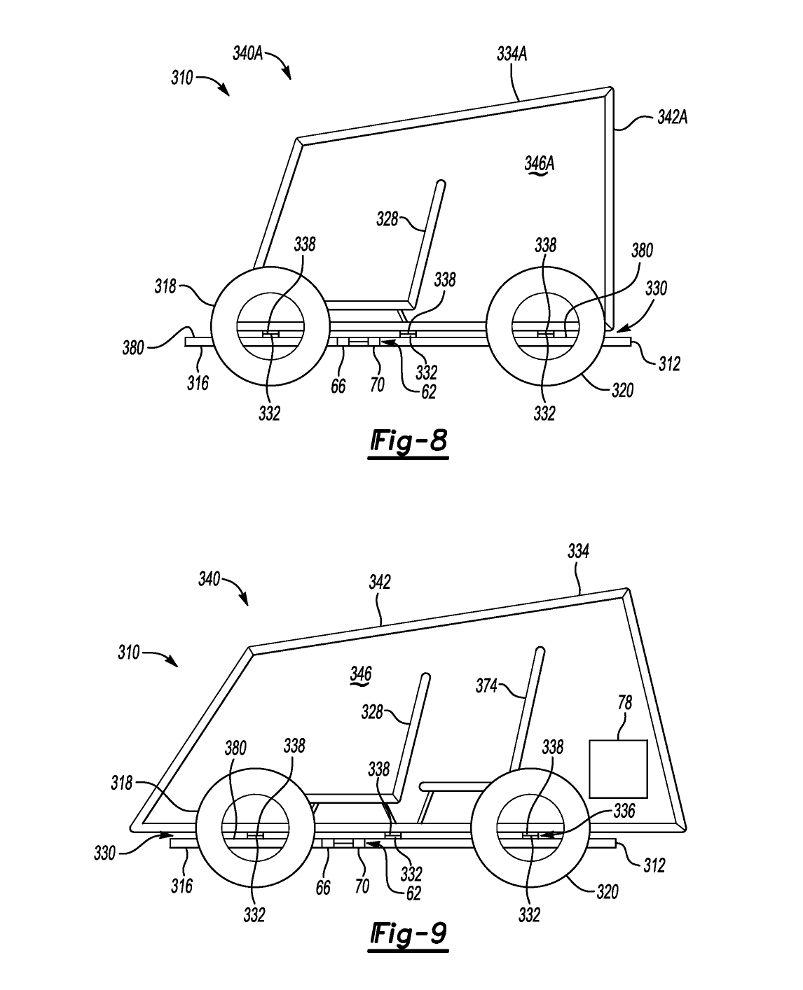

Referring to FIGS. 8 and 9, wherein like reference numbers refer to like components from FIGS. 1-7, an expandable vehicle system 310 includes a base unit 312 having a frame 316, front wheels 318 rotatably mounted with respect to the frame 316, rear wheels 320 rotatably mounted with respect to the frame 316, and a battery-electric propulsion system 62 mounted with respect to the frame 316. The frame 316 is a chassis frame configured for body-on-frame vehicle architecture. The base unit 312 in the embodiment depicted does not include a vehicle body or body portion defining an interior compartment. The base unit 312 also includes a steering system (not shown) and a braking system (not shown).

The base unit 312 has a first attachment interface 330 mounted with respect to the frame 316. In the embodiment depicted, the first attachment interface 330 includes mechanical fasteners, and, more specifically, the mechanical fasteners are vehicle body mounts 332. The expandable vehicle system 310 also includes two rear modules, or extension modules, that are selectively, releasably engageable at the first attachment interface 330. More specifically, the expandable vehicle system 310 includes a first extension module, shown at 334 in FIG. 9, and a second extension module, shown at 334A in FIG. 8.

Referring specifically to FIG. 9, the first extension module 334 includes a vehicle body portion 342. It should be noted that, as used herein, a “body portion” may include an entire body or a smaller portion thereof. Body portion 342 is an entire, or substantially entire, vehicle body. The first extension module 334 also includes a second attachment interface 336 that is mounted to the body portion 342; in the embodiment depicted, the second attachment interface 336 includes mechanical fastening elements 338 that are selectively and releasably engageable with the body mounts 332 of the first attachment interface 330 to connect the first extension module 334 to the base unit 312 such that the first extension module 334 and the base unit 312 form a single drivable unit 340, as shown in FIG. 9.

The body portion 342 of the first extension module 334 defines an interior compartment 346. The battery-electric powertrain or propulsion system 62 mounted with respect to the frame 16 includes an electric motor 66 operatively connected to an energy storage device, such as a battery 70. The motor 66 is operatively connected to at least one of the vehicle wheels 318, 320 to transmit torque thereto and thereby propel the vehicle system 310.

The first extension module 334 also includes an auxiliary power unit 78 mounted with respect to the first vehicle body portion 342. As used herein, an “auxiliary power unit” is any device that produces power to propel the vehicle system 310; examples of auxiliary power units 78 include torque-producing devices, such as internal combustion engines, that transmit torque to at least one of the wheels 318, 320. Other auxiliary power units 78 within the scope of the claimed invention may generate electrical energy to power the electric motor 66 or recharge the battery 70, such as an internal combustion engine in combination with a generator, or a fuel cell. Accordingly, the interfaces 330, 336 may include an electrical interface to transmit control signals to the auxiliary power unit 78 or to transmit electrical energy from the auxiliary power unit 78 to the battery 70 and/or the motor 66.

Referring again to FIG. 8, the second extension module 334A includes a body portion 342A. The second extension module 334A also includes a third attachment interface 336A that is mounted with respect to the body portion 342A; in the embodiment depicted, the third attachment interface 336A includes mechanical fastening elements 338 that are selectively and releasably engageable with the body mounts 332 of the first attachment interface 330 to rigidly connect the second extension module 334A to the base unit 312 such that the base unit 312 and the second extension module 334A form a single, drivable unit 340A. Body portion 342A is an entire, or substantially entire, vehicle body.

The body portion 342A defines an interior compartment 346A. Referring to FIGS. 8 and 9, the interior compartment 346A of the second extension module 334A is shorter and smaller than the interior compartment 346 of the first extension module 334. The second extension module 334A is characterized by the absence of an auxiliary power unit 78, and thus drivable unit 340A is a compact electric vehicle. Accordingly, the second extension module 334A may be used, for example, for one or two people commuting short distances. The second extension module 334A includes a driver's seat 328.

When a user of the vehicle system 310 desires additional cargo space, passenger capacity, and/or driving range before recharging the battery 70, the user may remove the second extension module 334A from the base unit 312 (by disengaging the fastening elements 338 of the third attachment interface 336A from the fastening elements 332 of the first attachment interface 330) and then engage the fastening elements 338 of the second attachment interface 336 with the fastening elements 332 of the first attachment interface 330 to attach the first extension module 334 to the base unit 312. The first extension module 334 provides increased cargo space and/or passenger capacity compared to the second extension module 334A, and the auxiliary power unit 78 provides additional power and or/driving range to the vehicle system 310. When a user of the vehicle system 310 desires a compact, electric-only vehicle, then the user may disconnect the first extension module 334 from the base unit 312 and then connect the second extension module 334A to the base unit 312. In the embodiment depicted, the first extension module 334 has both a driver's seat 328 and at least one passenger seat 374 mounted to the body portion 342 and disposed within the interior compartment 346.

Accordingly, the base unit 312 is a chassis including at least three wheels 318, 320 mounted with respect to the frame 316. The frame 316 is characterized by an upper face 380. The first attachment interface 330 includes body mounts 332 exposed at the upper face 380, and the first vehicle body portion 342 is an entire vehicle body. The second extension module 334A has a second vehicle body portion 342A and a third attachment interface 336A mounted with respect to the third vehicle body portion 342A. The first and third attachment interfaces 330, 336A are configured to selectively and releasably engage one another such that the second extension module 334A and the base unit 312 form a single drivable unit 340A when the first and third attachment interfaces 330, 336A are engaged with one another. The second extension module 334A is characterized by the absence of an auxiliary power unit 78.

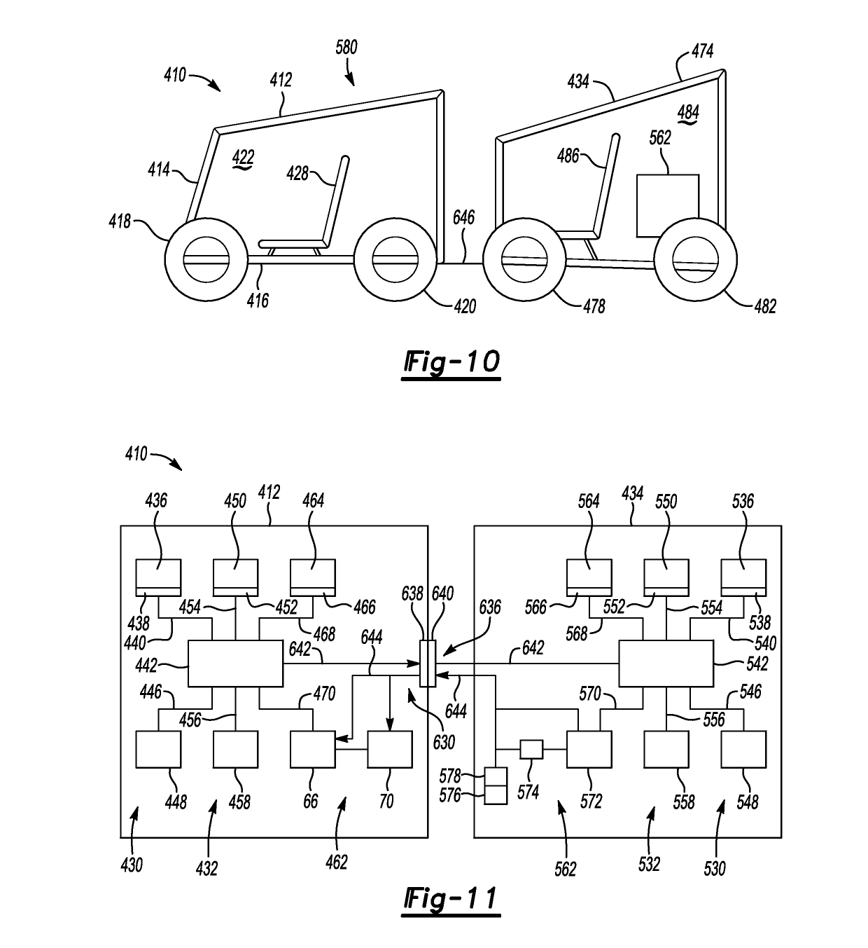

Referring to FIGS. 10 and 11, wherein like reference numbers refer to like components from FIGS. 1-9, an expandable vehicle system 410 includes a base unit 412 having a frame 416, front wheels 418 rotatably mounted with respect to the frame 416, rear wheels 420 rotatably mounted with respect to the frame 416, and a battery-electric propulsion system (shown at 462 in FIG. 11) mounted with respect to the frame 416. The base unit 412 includes a body portion 414 mounted with respect to the frame 416. The body portion 414 defines an interior compartment 422. A seat 428 is mounted with respect to the body portion 414 and is disposed within the interior compartment 422.

The base unit 412 includes a steering system 430 and a braking system 432. Accordingly, with a vehicle body, propulsion system 462, steering system 430, and braking system 432, the base unit 412 forms a compact, electric vehicle that is independently drivable without and extension module. The steering system 430 and the braking system 432 are “by wire,” i.e., they are controllable via electronic or other non-mechanical control signals. Referring specifically to FIG. 11, the steering system 430 includes a steering input device 436, such as a steering wheel, which is manipulatable by a human vehicle driver to control the steering system 430. For example, the human vehicle driver inputs mechanical steering signals into the steering system 430 by changing the angular position of the steering wheel and the angular velocity of the steering wheel. A steering transducer 438 detects the angular position of the steering wheel and the angular velocity of the steering wheel and converts these mechanical steering signals to electronic or other non-mechanical steering input signals 440. The steering transducer 438 is operatively connected to a control unit 442 and transmits the steering input signals 440 to the control unit 442. A control unit typically includes a microprocessor, ROM and RAM and appropriate input and output circuits of a known type for receiving the various input signals and for outputting various control commands to the actuators.

The control unit 442 processes the steering input signals 440 in combination with various sensor signals and in accordance with a predetermined algorithm to generate steering actuator control signals 446. The control unit 442 is operatively connected to a steering actuator 448 and transmits the steering actuator control signals 446 thereto. The steering actuator 448 is operably connected to the front wheels 418 and configured to adjust the steering angle of the front wheels 418 in response to the control signals 446 from the control unit 442. Actuators in a by-wire system transform electronic (or other non-mechanical) control signals into a mechanical action or otherwise influence a system's behavior in response to the control signals. Examples of actuators that may be used in a by-wire system include electromechanical actuators such as electric servomotors, translational and rotational solenoids, magnetorheological actuators, electrohydraulic actuators, and electrorheological actuators. Those skilled in the art will recognize and understand mechanisms by which the steering angle may adjusted. In one embodiment, the steering actuator 448 is an electric drive motor configured to adjust a mechanical steering rack.

Similarly, the braking system 432 includes a braking input device 450, such as a brake pedal, which is manipulatable by a human vehicle driver to control the braking system 432. For example, the human vehicle driver inputs mechanical braking signals into the braking system 432 by changing the position of the brake pedal relative to the body portion 414 and the velocity of the brake pedal relative to the body portion 414. A braking transducer 452 detects the position of the brake pedal relative to the body portion 414 and the velocity of the brake pedal relative to the body portion 414, and converts these mechanical braking signals to electronic or other non-mechanical braking input signals 454. The braking transducer 452 is operatively connected to the control unit 442 and transmits the braking input signals 454 to the control unit 442.

The control unit 442 processes the braking input signals 454 in combination with various sensor signals and in accordance with a predetermined algorithm to generate braking actuator control signals 456. The control unit 442 is operatively connected to a braking actuator 458 and transmits the braking actuator control signals 456 thereto. The braking actuator 458 is configured to reduce the angular velocity of the wheels 418, 420 in response to the braking actuator control signals 456. Those skilled in the art will recognize the manner in which the braking actuator 458 acts on the wheels 418, 420. Typically, actuators cause contact between friction elements, such as pads and disc rotors. Optionally, an electric motor may function as a braking actuator in a regenerative braking system.

The propulsion system 462 in the embodiment of FIGS. 10 and 11 includes by-wire control. The propulsion system 462 includes a propulsion system input device 464, such as an accelerator pedal, which is manipulatable by a human vehicle driver to control the propulsion system 462. For example, the human vehicle driver inputs mechanical propulsion signals into the propulsion system 462 by changing the position of the accelerator pedal relative to the body portion 414 and the velocity of the accelerator pedal relative to the body portion 414. A propulsion transducer 466 detects the position of the accelerator pedal relative to the body portion 414 and the velocity of the accelerator pedal relative to the body portion 414, and converts these mechanical propulsion signals to electronic or other non-mechanical propulsion input signals 468. The propulsion transducer 466 is operatively connected to the control unit 442 and transmits the propulsion input signals 468 to the control unit 442.

The control unit 442 processes the propulsion input signals 468 in combination with various sensor signals and in accordance with a predetermined algorithm to generate propulsion control signals 470. The control unit 442 is operatively connected to the motor 66 and transmits the propulsion control signals 470 thereto. The motor 66 is responsive to the propulsion control signals 470 to vary to the amount of torque and power applied by the motor 66 to the wheels 418, 420. The motor 66 is operatively connected to the battery 70 to receive electrical energy therefrom.

The expandable vehicle system 410 also includes an extension module 434 having a body portion 474, front wheels 478 rotatably mounted with respect to body portion 474, and rear wheels 482 rotatably mounted with respect to body portion 474. The body portion 474 defines an interior compartment 484. A seat 486 is mounted with respect to the body portion 474 and is disposed within the interior compartment 484.

The extension module 434 includes a steering system 530, a braking system 532, and a propulsion system 562. Accordingly, with a vehicle body 474, propulsion system 562, steering system 530, and braking system 532, the extension module 434 forms a vehicle that is independently drivable without the base unit 412.

The steering system 530 and the braking system 532 are “by wire,” i.e., they are controllable via electronic or other non-mechanical control signals. Referring specifically to FIG. 11, the steering system 530 includes a steering input device 536, such as a steering wheel, which is manipulatable by a human vehicle driver to control the steering system 530. For example, the human vehicle driver inputs mechanical steering signals into the steering system 530 by changing the angular position of the steering wheel and the angular velocity of the steering wheel. A steering transducer 538 detects the angular position of the steering wheel and the angular velocity of the steering wheel and converts these mechanical steering signals to electronic or other non-mechanical steering input signals 540. The steering transducer 538 is operatively connected to a control unit 542 and transmits the steering input signals 540 to the control unit 542. A control unit typically includes a microprocessor, ROM and RAM and appropriate input and output circuits of a known type for receiving the various input signals and for outputting various control commands to the actuators.

The control unit 542 processes the steering input signals 540 in combination with various sensor signals and in accordance with a predetermined algorithm to generate steering actuator control signals 546. The control unit 542 is operatively connected to a steering actuator 548 and transmits the steering actuator control signals 546 thereto. The steering actuator 548 is operably connected to the front wheels 478 and configured to adjust the steering angle of the front wheels 478 in response to the control signals 546 from the control unit 542.

Similarly, the braking system 532 includes a braking input device 550, such as a brake pedal, which is manipulatable by a human vehicle driver to control the braking system 532. For example, the human vehicle driver inputs mechanical braking signals into the braking system 532 by changing the position of the brake pedal relative to the body portion 474 and the velocity of the brake pedal relative to the body portion 474. A braking transducer 552 detects the position of the brake pedal relative to the body portion 474 and the velocity of the brake pedal relative to the body portion 474, and converts these mechanical braking signals to electronic or other non-mechanical braking input signals 554. The braking transducer 552 is operatively connected to the control unit 542 and transmits the braking input signals 554 to the control unit 542.

The control unit 542 processes the braking input signals 554 in combination with various sensor signals and in accordance with a predetermined algorithm to generate braking actuator control signals 556. The control unit 542 is operatively connected to a braking actuator 558 and transmits the braking actuator control signals 556 thereto. The braking actuator 558 is configured to reduce the angular velocity of the wheels 478, 482 in response to the braking actuator control signals 556.

The propulsion system 562 in the embodiment of FIGS. 10 and 11 includes by-wire control. The propulsion system 562 includes a propulsion system input device 564, such as an accelerator pedal, which is manipulatable by a human vehicle driver to control the propulsion system 562. For example, the human vehicle driver inputs mechanical propulsion signals into the propulsion system 562 by changing the position of the accelerator pedal relative to the body portion 414 and the velocity of the accelerator pedal relative to the body portion 474. A propulsion transducer 566 detects the position of the accelerator pedal relative to the body portion 474 and the velocity of the accelerator pedal relative to the body portion 474, and converts these mechanical propulsion signals to electronic or other non-mechanical propulsion input signals 568. The propulsion transducer 566 is operatively connected to the control unit 542 and transmits the propulsion input signals 568 to the control unit 542.

The control unit 542 processes the propulsion input signals 568 in combination with various sensor signals and in accordance with a predetermined algorithm to generate propulsion control signals 570. The control unit 542 is operatively connected to an electric motor 572 and transmits the propulsion control signals 570 thereto. The motor 572 is responsive to the propulsion control signals 570 to vary to the amount of torque and power applied by the motor 572 to the wheels 478, 482. The motor 572 is operatively connected to a battery 574 to receive electrical energy therefrom.

The propulsion system 562 also includes an electrical generation subsystem, which, in the embodiment depicted, is an engine 576 operatively connected to an electrical generator 578. The electrical generator 578 is operatively connected to the battery 574 and the motor 572 to selectively transmit electrical energy thereto.

The base unit 412 includes a first attachment interface 630 mounted with respect to the frame 416. The extension module 434 includes a second attachment interface 636 mounted with respect to the body portion 474. The first and second attachment interfaces 630, 636 are configured to selectively and releasably engage one another such that the extension module 474 and the base unit 412 form a single drivable unit 580 when the first and second attachment interfaces 630, 636 are engaged with one another.

In the embodiment of FIGS. 10 and 11, the first interface 630 is at least one electrical connector 638 operatively connected to the control unit 442, the battery 70, and the motor 66, such as by wires. The second interface 636 is at least one electrical connector 640 that is operatively connected to the control unit 542 and the generator 578, such as by wires. When electrical connector 638 is engaged with electrical connector 640, control signals 642 from control unit 442 are transmittable to control unit 542 through the connectors 638, 640. Similarly, when electrical connector 638 is engaged with electrical connector 640, electrical energy 644 is transmittable from the generator 578 to the battery 70 and the motor 66 through the electrical connectors 638, 640.

The propulsion system 562 is thus an auxiliary power unit that can supplement the energy requirements of the base unit 412. Control signals 642 from the base unit 412 control the steering system 530, braking system 532, and propulsion system 562 of the extension unit 434. The control unit 442 is configured to generate the control signals 642 in response to the inputs from input devices 436, 450, 464 such that the extension unit 434 follows the base unit 412 and remains within a predetermined range of the base unit 412 (determined in part by the length of the flexible wires 646 connecting electrical connector 640 and the body 474. In this manner, the base unit 412 and the extension module 434 form a single, drivable unit 580. It should be noted that the interfaces 630, 636 do not transmit significant mechanical forces between the base unit 412 and the extension unit 434; instead, only electrical energy and non-mechanical (electrical) control signals are transmitted between the base unit 412 and the extension module 434 when the interfaces 630, 636 are engaged with one another.

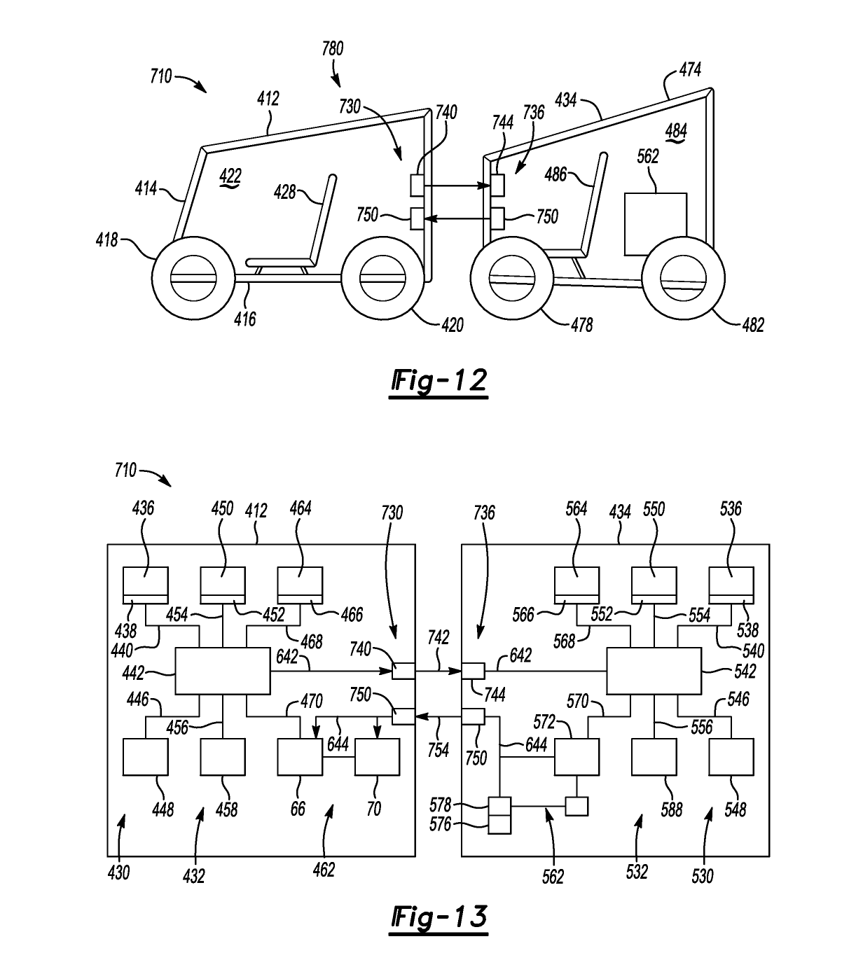

Referring to FIGS. 12 and 13, wherein like reference numbers refer to like components from FIGS. 1-11, the expandable vehicle system 710 is substantially identical to the expandable vehicle system 410 of FIGS. 10 and 11, except for interfaces 730, 736. Interface 730 of the base unit 412 is mounted with respect to the frame 416 and includes a wireless transceiver 740 (transmitter/receiver) configured to send wireless control signals 742 from the base unit 412 to the extension module 434. The interface 736 of the extension module 434 is mounted with respect to the body portion 474, and includes a transceiver 744 configured to receive the wireless signals 742. The transceiver 740 is operatively connected to the control unit 442 to receive control signals 642 therefrom, and convert the control signals 642 to wireless form 742. The transceiver 744 is operatively connected to control unit 542, and converts the wireless control signals 742 back to electronic control signals 642, which are transmitted to the control unit 542.

Interface 736 and interface 730 also include respective inductive couplings 750. The inductive coupling 750 of interface 730 is operatively connected to the motor 66 and the battery 70. The inductive coupling 750 interface 736 is operatively connected to the generator 578. Accordingly, the interfaces 730, 736 provide wireless power transmission from the generator 578 of the extension module 434 to the propulsion system 462 of the base unit 412.

It should be noted that, in the embodiment of FIGS. 12 and 13, the interfaces 730, 736 are characterized by the absence of any physical connections between the base unit 412 and the extension module 434 when the interfaces 730, 736 are engaged with each other to form the single, drivable unit 780.

While the best modes for carrying out the many aspects of the present teachings have been described in detail, those familiar with the art to which these teachings relate will recognize various alternative aspects for practicing the present teachings that are within the scope of the appended claims.

1. An expandable vehicle system comprising:
a base unit having a frame, a first wheel rotatably mounted with respect to the frame, and a battery-electric propulsion system mounted with respect to the frame;
a first extension module having a first vehicle body portion and an auxiliary power unit mounted with respect to the first vehicle body portion;
wherein the base unit has a first attachment interface mounted with respect to the frame and the first extension module has a second attachment interface mounted with respect to the first vehicle body portion;
wherein the first and second attachment interfaces are configured to selectively and releasably engage one another such that the first extension module and the base unit form a single drivable unit when the first and second attachment interfaces are engaged with one another.

2. The expandable vehicle system of claim 1, wherein the base unit includes a second vehicle body portion mounted with respect to the frame;
wherein the first vehicle body portion defines a first interior compartment having a first opening;
wherein the second vehicle body portion defines a second interior compartment having a second opening; and
wherein the first attachment interface is positioned with respect to the second vehicle body portion, and the second attachment interface is positioned with respect to the first vehicle body portion, such that the first and second interior compartments are contiguous when the first and second attachment interfaces are engaged with each other.

3. The expandable vehicle system of claim 2, further comprising a second extension module having a third vehicle body portion and a third attachment interface mounted with respect to the third vehicle body portion;
wherein the first and third attachment interfaces are configured to selectively and releasably engage one another such that the second extension module and the base unit form a single drivable unit when the first and third attachment interfaces are engaged with one another.

4. The expandable vehicle system of claim 3, wherein the third vehicle body portion defines a third interior compartment having a third opening;
wherein the first attachment interface is positioned with respect to the second vehicle body portion, and the third attachment interface is positioned with respect to the third vehicle body portion such that the third and second interior compartments are contiguous when the first and third attachment interfaces are engaged with each other; and
wherein the third interior compartment is smaller than the first interior compartment.

5. The expandable vehicle system of claim 4, wherein the second extension module is characterized by the absence of an auxiliary power unit.

6. The expandable vehicle system of claim 2, wherein the first extension module includes a second wheel mounted with respect to the first vehicle body portion.

7. The expandable vehicle system of claim 6, wherein the base unit includes a third wheel that is selectively retractable.

8. The expandable vehicle system of claim 7, wherein the base unit includes at least three wheels.

9. The expandable vehicle system of claim 2, wherein the base unit includes a closure configured to selectively obstruct the second opening.

10. The expandable vehicle system of claim 1, wherein the frame includes a first frame portion and a second frame portion; and
wherein the second frame portion is selectively movable with respect to the first frame portion to change the length of the frame.

11. The expandable vehicle system of claim 10, wherein the base unit further includes a second wheel;
wherein the first wheel is mounted with respect to the first frame portion;
and wherein the second wheel is mounted with respect to the second frame portion.

12. The expandable vehicle system of claim 1, wherein the base unit is a chassis including at least three wheels mounted with respect to the frame;
wherein the frame is characterized by an upper face;
wherein the first attachment interface includes body mounts exposed at the upper face; and
wherein the first vehicle body portion is an entire vehicle body.

13. The expandable vehicle system of claim 12, further comprising a second extension module having a second vehicle body portion and a third attachment interface mounted with respect to the second vehicle body portion;
wherein the first and third attachment interfaces are configured to selectively and releasably engage one another such that the second extension module and the base unit form a single drivable unit when the first and third attachment interfaces are engaged with one another; and
wherein the second extension module is characterized by the absence of an auxiliary power unit.

14. The expandable vehicle system of claim 1, wherein the base unit includes a first steering system and a first braking system;
wherein the first extension module includes a second steering system and a second braking system; and
wherein the first and second attachment interfaces are configured to transmit control signals from the base unit to the second steering system, the second braking system, and the auxiliary power unit.

15. The expandable vehicle system of claim 14, wherein the first and second attachment interface are configured to selectively transmit energy from the auxiliary power unit to the battery-electric propulsion system.

16. The expandable vehicle system of claim 15, wherein the first attachment interface includes at least one base unit electrical connector;
wherein the second attachment interface includes at least one extension module electrical connector operatively connected to the second steering system, the second braking system, and the auxiliary power unit; and
wherein said at least one base unit electrical connector and said at least one extension module electrical connector are configured to transmit control signals to the second steering system, the second braking system, and the auxiliary power unit from the base unit when said at least one base unit electrical connector and said at least one extension module electrical connector are operatively interconnected.

17. The expandable vehicle system of claim 15, wherein the first attachment interface includes at least one wireless transmitter;
wherein the second attachment interface includes at least one wireless receiver operatively connected to the second steering system, the second braking system, and the auxiliary power unit; and
wherein said at least one wireless transmitter and said at least one wireless receiver are configured to transmit control signals to the second steering system, the second braking system, and the auxiliary power unit from the base unit when said at least wireless transmitter and said at least one wireless receiver are in communication with one another.

18. The expandable vehicle system of claim 17, wherein the first and second attachment interfaces are configured to transmit energy from the extension module to the base unit via induction.

19. The expandable vehicle system of claim 15, wherein the first extension module includes a steering input device operatively connected to the steering system, and a braking input device operatively connected to the braking system such that the first extension module is drivable independently of the base unit.
